(19) United States
(12) Patent Application Publication
(10) Pub. No.: US 2016/0041016 A1
(43) Pub. Date: Feb. 11, 2016

(54) Verfahren und Wirbelströmungsmessgerät Zur Bestimmung des Massenstromverhältnisse einermhrphasigen Strömung

(71) Applicant: ENDRESS+HAUSER FLOWTEC AG, Reinach (BL) (CH)

(72) Inventors: Christoph Gossweiler, Winterthur (CH); Rainer Hocker, Waldshut (DE); Marc Hollmach, Basel (CH); Christian Kahr, Suhr (CH); Silvio Krauss, Schneisingen (CH); Dirk Sutterlin, Schopfheim (DE); Daniel Wymann, Schneisingen (CH)

(21) Appl. No.: 14/652,847

(22) PCT Filed: Nov. 25, 2013
(86) PCT No.: PCT/EP2013/074636

§ 371 Date: Oct. 5, 2015

(30) Foreign Application Priority Data
Dec. 21, 2012 (DE) 10 2012 112 976.2

(51) Int. Cl. G01F 1/32

(52) U.S. Cl. CPC G01F 1/3209; G01F 1/3254

(57) ABSTRACT

A vortex flow measuring device as well as a method for determining by means of a vortex, flow measuring a device, which has a bluff body protruding into the flowing medium and a vortex sensor, the mass flow ratio (x) of an at least at times two- or multiphase medium flowing in a measuring tube and having a gaseous first phase flowing with a first mass flow rate \dot{m}_{G} and a liquid second phase flowing with a second mass flow rate \dot{m}_{L}. The gaseous phase has a first density (ρ_{G}), which differs from a second density (ρ_{L}) of the liquid phase, comprising: producing Kármán vortices in the flowing medium at least in the region of the vortex sensor by means of the bluff body, the vortices are shed from the bluff body with a vortex shedding frequency (fᵥ) dependent on an instantaneous flow velocity of the flowing medium; registering by means of the vortex sensor periodic pressure fluctuations caused by the Kármán vortex in the flowing medium for producing a sensor signal corresponding to the pressure fluctuations; selecting from the sensor signal a wanted signal component, which has a frequency band, especially a narrow frequency band, containing the vortex shedding frequency, especially with a relative bandwidth less than 50% of the instantaneous vortex shedding frequency, wherein preferably the instantaneous vortex shedding frequency represents the center frequency of the frequency bandwidth; and applying the wanted signal component (M) for determining a mass flow ratio (x) of the flowing medium, wherein the mass flow ratio (x) is defined as a ratio of the first mass flow \dot{m}_{G} to a total mass flow, with which the medium flows, especially according to a formula:

$$x = \frac{{\dot{m}}_{G}}{{\dot{m}}_{L} + {\dot{m}}_{G} } .$$

The invention relates to a method for determining mass flow ratio as defined in the preamble of claim 1 and to a vortex flow measuring device as defined in the preamble of claim 19.

Known from the state of the art are various measuring devices for measuring flow of a fluid medium, most often gas flows or vapor flows in the high temperature region, in pipelines. The flows can, at least at times, be present as two- or multiphase flows of the fluid medium. They include, in such case, first and second phases, wherein the first phase is most often a gas, such as, for example, steam, and the second phase a condensate, such as, for example, water. This type of flow can be measured by measuring apparatuses, such as Venturi nozzles, orifice or cone pressure difference meters, and the like. In such case, principally the volume flow rate \dot{V} of the gas in the, at least at times, two- or multiphase flow is measured and is, in such case, directly dependent on the mass flow \dot{m}_{G} (which designates the transport of a medium in a unit time through a defined cross section) and the reciprocal density:

$$\dot{V} = \frac{d m}{d t} / ρ = \frac{{\dot{m}}_{G}}{ρ} . \qquad ( 1 )$$

Furthermore, known from the state of the art are vortex flow measuring devices, which operate based on the principle of the Kármán vortex street and were applied previously for one phase flows. However, these measuring devices can also be applied for two phase or multiphase flows.

DE 10 2009 001 525 A1 as well as DE 10 2009 001 526 A1 describe such vortex flow measuring devices for monitoring and measuring an, at times, two- or multiphase medium flowing in a pipeline. In such case, DE 10 2009 001 526 A1 discloses a measuring device and a pipeline, into which at least one measuring tube is insertable. Further present are a bluff body and a vortex sensor, which responds to the arising pressure fluctuations and transduces these into electrical signals.

DE 10 2009 001 525 A1 describes a method for monitoring, respectively measuring, an aforementioned medium, wherein Kármán type vortices are produced in the flowing medium. The vortices shed from the bluff body with a vortex shedding frequency f_{V} (also called the vortex frequency), which depends on an instantaneous flow velocity of the flowing medium. The pressure fluctuations produced by the vortices are registered by the vortex sensor. The volume flow rate of the gaseous, first phase can be determined from the vortex shedding frequency f_{V}. Selected from the sensor signal S is, furthermore, a wanted signal component M having a narrow frequency band. The relative bandwidth is, in such case, less than 50% of the instantaneous vortex shedding frequency f_{V}. By means of the wanted signal component, based on a standard deviation of an amplitude curve and/or a kurtosis of the wanted signal component and/or the sensitivity of the vortex sensor, a volume flow of the second, liquid phase can be calculated.

In the case of flow measurement with a vortex flow measuring device, there results during the measuring of an, at least at times, two- or multiphase flow a measurement error dependent on the mass flow fraction of the liquid phase. This measurement error can amount to up to a multiple of the measurement uncertainty of the vortex flow measuring device and, thus, can be several percent. This measurement error increases with increasing mass flow fraction of the liquid phase,

$${E}_{m} = \frac{{\dot{m}}_{G , Vortex} - {\dot{m}}_{G}}{{\dot{m}}_{G , Vortex}} , \qquad ( 2 )$$

wherein Eₘ is the measurement error, \dot{m}_{G,Vortex} of the measured mass flow and \dot{m}_{G} the mass flow of the gaseous phase.

Starting from this state of the art, an object of the present invention is to reduce measurement error caused by the mass flow fraction of the liquid phase to the gas phase and to enable an exact measuring of the volume flow of the gaseous phase and therefrom derived measured variables, especially mass flow of the gas phase.

This object is achieved by a flow measuring method for determining the mass flow ratio x, as such method is defined in the independent claim 1.

Another object is to provide a vortex flow measuring device, which enables a simple and fast measuring of the flow rate of a gaseous phase in an, at least at times, two- or multiphase flow. This object is achieved by a vortex flow measuring device as defined in independent claim 19.

Preferred forms of embodiment are subject matter of the dependent claims.

The method of the invention is a method for determining the mass flow ratio (x) of a medium flowing in a measuring tube and composed of a number of gaseous and liquid phases, wherein at least at times besides the gaseous phase a phase can be liquid, in a vortex flow measuring device having a sensor for producing a sensor signal S correlated with a vortex shedding frequency fᵥ. In such case, the gaseous phase has a first density (ρ_{G}), which typically is different from a second density (ρ_{L}) of the liquid phase. In a first step, there occurs a producing of a Kármán vortex street in the flowing medium at least in the region of the vortex sensor by means of the bluff body, wherein the vortices are shed from the bluff body with a vortex shedding frequency (fᵥ) dependent on an instantaneous flow velocity of the flowing medium. In a second step, there occurs the registering, by means of the vortex sensor, of periodic pressure oscillations caused by Kármán vortices in the flowing medium, in order to produce a sensor signal S corresponding to the pressure fluctuations. Furthermore, in a third step, a wanted signal component M is selected from the sensor signal S, which has an especially narrow frequency band containing the vortex shedding frequency, especially with a relative bandwidth less than 50% of the instantaneous vortex shedding frequency, wherein preferably the instantaneous vortex shedding frequency corresponds to the center frequency of the frequency bandwidth. Thereafter, the wanted signal component (M) can be applied for determining a mass flow ratio (x) of the flowing medium, wherein the mass flow ratio (x) is defined as a ratio of the first mass flow \dot{m}_{G} of the gaseous phase to a total mass flow with which the medium flows, especially according to the formula:

$$x = \frac{{\dot{m}}_{G}}{{\dot{m}}_{L} + {\dot{m}}_{G}} .$$

With the method of the invention, it is possible in comparison to previous methods significantly to reduce a measurement error Eₘ in the case of measuring mass and volume flow of the gaseous phase(s) in the case of a present multiphase flow. In such case, it is advantageous that the mass flow ratio does not have to be known to the user, since this information is contained in the sensor signal S. Furthermore, a unique and stable utilizing of the measurement signal can occur, because an evaluation can be performed independently of the amplitude value of the signal.

Furthermore, it can be provided according to the invention that the determining of the first density ρ_{G} of the gaseous phase or the second density ρ_{L} of the liquid phase can occur by inputting or by measuring with parameters correlating with density, especially a temperature or a pressure within the two-phase medium. In this regard, the two densities ρ_{L}, ρ_{G} can be input or predetermined externally via a data processing unit, which can be operatively connected with the measuring device. This is especially advantageous in the case of known media. Alternatively, the densities can be predetermined individually or by means of suitable sensors during a calibrating or also measured directly in the measuring device during the measuring. Therewith, also time-dependent fluctuations of the densities can be registered. Furthermore, also the measured variables pressure and/or temperature correlated with the density can be read into the data processing unit from other measuring devices by means of an in/output unit via fieldbus interfaces (e.g. 4-20 mA, HART, PA,FF).

Preferably, the vortex shedding frequency f_{V} can be determined by means of an evaluating-electronics present in the measuring device, such as is generally known in the case of vortex flow measuring devices. Via the vortex shedding frequency f_{V}, in turn, then by means of the evaluating-electronics in known manner the flow velocity of the gaseous phase of a two-phase medium flowing in a pipeline can be determined.

The evaluating-electronics can, moreover, however, also perform a quantitative determining of the wall flow, such as is especially described in DE 10 2009 001 526 A1. This is not explicitly explored here.

It is advantageous to select the wanted signal component from the sensor signal S in a narrowband around the vortex shedding frequency f_{V} by means of a suitable filter, wherein a relative bandwidth can be less than 50% of a center frequency corresponding to the vortex shedding frequency. There are, however, also adaptations of the bandwidth possible, depending on requirements for the wanted signal component to be used. By means of a selective filtering, only the frequency ranges in the region around the vortex shedding frequency f_{V} can be taken into consideration, this meaning thus that disturbance fractions with frequencies, which differ from the vortex shedding frequency f_{V}, are filtered out.

According to the invention, the time dependent wanted signal component M as such in total is used, and the above mentioned variables determined therefrom. The wanted signal component M is composed of an amplitude referenced signal sampled at certain points in time and can be considered as such approximately by the following relationship:

M(t)=A₀(t)·sin(ω(t)), (3)

wherein A₀ is the time-dependent amplitude and ω the time-dependent phase of the sinusoidal oscillation, which here stands approximately for the phase of the vortex oscillation.

Especially, the time fluctuations of the sinusoidal signals of every signal value are taken into consideration, for which in an additional step the determining of at least one fluctuation value of the wanted signal component (M) can occur over a time interval, wherein the wanted signal component (M) in the time interval includes preferably more than one period of the pressure fluctuations of the flow. The advantage of applying fluctuation values of the wanted signal component is that these time fluctuations deliver more stable information concerning the state of the flow than the pure applying of the amplitude of the sensor signal or the wanted signal component, since the entire provided signal is taken into consideration for evaluation and not only the maximum values or alternatively the RMS-values, as is the case for an amplitude measuring method. Alternatively, the sensor signal S can also be evaluated directly with the full bandwidth. However, there are disadvantages in such case, since additional disturbance components can be contained in the signal, which can controllingly influence the evaluating of the fluctuation values and lead to incorrect determining of the mass flow ratio.

In a vortex flow measuring system, the volume flow rate \dot{V} is measured essentially from the vortex shedding frequency f_{V}. The latter can be used to calculate a flow velocity, which in first approximation is directly proportional to the volume flow rate \dot{V} of the medium. From the volume flow, in a further development of the invention, also a pure mass flow \dot{m} of the gaseous phase can be determined and output.

In order to be able to make appropriate statements concerning the mass flow ratio of the multiphase flow, it is necessary that earlier a statistical evaluation of the wanted signal component selected from the sensor signal S occurs. In such case, the invention provides preferably that in an additional step the determining of at least one fluctuation value of the wanted signal component (M) occurs over a time interval, wherein the wanted signal component (M) includes in the time interval preferably more than one period of the pressure fluctuations of the flow, especially a standard deviation (σ) of an amplitude curve of the wanted signal component and/or a kurtosis (Ku) of the wanted signal component.

For statistical evaluation, a standard deviation a of an amplitude curve of the wanted signal component M as well as the kurtosis Ku of the wanted signal component M of the sensor signal S can be ascertained, such as is described also in DE 10 2009 001 525 A1 or DE 10 2009 001 526 A1. The standard deviation a or the kurtosis Ku can be taken into consideration for ascertaining the mass flow ratio (x) of the multiphase flow, when the flow velocity of the gaseous phase lies above a minimum limit flow velocity to be determined, which can on its part be dependent on the respective vortex flow measuring device. The kurtosis Ku can as normalized fourth central moment be a measure for the slope of a statistical distribution. Furthermore, also the moments, variance and skewness are determinable for additional evaluation of the measurement signal.

Preferably, a form of embodiment of the invention can provide that in an additional step applying the wanted signal component M the mass flow ratio x of the gaseous phase to the liquid phase can be determined. In order to describe the flow measurement achieved here, diverse characteristic variables must be considered. These characteristic variables can be used in combination.

Thus, besides the vortex shedding frequency f_{V}, the mass flow fraction x is an important characteristic variable:

$$x = \frac{{\dot{m}}_{G}}{{\dot{m}}_{L} + {\dot{m}}_{G}} ≡ \frac{{m}_{G}}{{m}_{L} + {m}_{G}} \qquad ( 4 )$$

The ratio of the mass flows \dot{m}_{G} of the gaseous phase and \dot{m}_{L} of the liquid phase is also referred to as the mass flow fraction x and is referred to in steam flows also often as steam quality or steam content. It expresses the ratio of the masses of the two phases of the flow in a certain unit time through the measuring tube cross section, wherein m_{G} is the mass of the gaseous phase and mL is the mass of the liquid phase. The mass flow ratio x can be won from the sensor signal corresponding to the pressure fluctuations and the general process conditions, wherein in an additional form of the invention the mass flow ratio x can be expressed as a function of the time-dependent wanted signal component M, the densities ρ_{L}, ρ_{G} and the vortex shedding frequency f_{V}:

x=f(g(M(t)),ρ_{G}(t),ρ_{L}(t),f_{V}(t)). (5)

The characteristic variables are, as a rule, time-dependent and can as such also be registered time-dependently in the measuring device.

A function g(M(t)) is necessary for determining the mass flow ratio x. This function is a measure of the fluctuation size of the wanted signal component M. Taken into consideration as fluctuation size can be especially the kurtosis Ku of the wanted signal component M or the standard deviation of the amplitude A₀(t) ascertained from the wanted signal component M.

g(M(t))=Ku(M(t))

g(M(t))=σ(A₀(t)) (5a)

For more exact determining of x, supplementally also the densities, ρ_{G}(t), ρ_{L}(t) and the vortex frequency f_{V}(t) can be taken into consideration.

Suitably, x can a be function of the kurtosis Ku and a Froude number, especially the densimetric Froude number Fr′:

$$Fr = \frac{{u}_{GS}}{\sqrt{D \cdot g}} \\ {Fr}^{′} = \sqrt{\frac{{ρ}_{G}}{{ρ}_{L} - {ρ}_{G}}} \cdot \frac{{u}_{GS}}{\sqrt{D \cdot g}} \\ x = f ( Ku , Fr ) . \\ x = f ( Ku , {Fr}^{′} ) \qquad ( 6 )$$

For example, the invention can provide that the mass flow fraction x is formed from polynomials of higher order, of the aforementioned variables Ku and Fr or Fr′, respectively also only based on the kurtosis Ku:

$$x = {a}_{00} + {a}_{10} \cdot Ku + {a}_{20} \cdot {Ku}^{2} + {a}_{01} \cdot {Fr}^{′} + {a}_{11} \cdot Ku \cdot {Fr}^{′} + {a}_{21} \cdot {Ku}^{2} \cdot {Fr}^{′} + … = {\sum }_{j = 0}^{M} {\sum }_{i = 0}^{N} {a}_{ij} \cdot {Ku}^{i} \cdot {Fr}^{{′}^{j}} ( N \geq 1 , M \geq 0 ) \\ x = {a}_{0} + {a}_{1} \cdot Ku + {a}_{2} \cdot {Ku}^{2} + … = {\sum }_{i = 0}^{N} {a}_{i} \cdot {Ku}^{i} ( N \geq 1 ) \qquad ( 7 )$$

The coefficients of the individual terms can be approached and determined in simple manner by fitting functions or other approximation functions.

The densimetric Froude number Fr′ is, in such case, —as ratio of inertial to gravitational force—a measure, for example, of the wave propagation velocity and is expressed as

$${Fr}^{′} = \sqrt{\frac{{ρ}_{G}}{{ρ}_{L} - {ρ}_{G}}} \cdot \frac{{u}_{GS}}{\sqrt{D \cdot g}} . \qquad ( 8 )$$

In such case, ups is an empty flow velocity and D a characteristic length of the measuring device and corresponds especially to the diameter of the measuring tube. The Froude number Fr thus includes the influence of the empty tube velocity of the gaseous phase. The Froude number Fr can advantageously be determined by applying the wanted signal component. In this regard, the empty flow velocity

$${u}_{GS} = \frac{{\dot{m}}_{G}}{{ρ}_{G} \cdot {A}_{M}}$$

in the pipe with cross sectional area A_{M} can be determined from the vortex shedding frequency f_{V}. The densities ρ_{G}, ρ_{L} of the two phases likewise play a role.

In a further development of the invention, alternatively the sensitivity c of a sensor can serve as a measure for obtaining the mass flow ratio x from the sensor signal S. In the case of a sinusoidal signal, the sensitivity c can be estimated from the slope at the zero intercept and the frequency of the sensor signal S. Preferably used for this, instead of the sensor signal, is the wanted signal component M:

$$c = \frac{{\vert \frac{d M}{d t} \vert}_{M = 0} \vert}{{ρ}_{G} {f}_{V}^{3}} . \qquad ( 9 )$$

From the sensitivity c of the sensor, an amplitude A′ can also be derived, even when the sinusoidal signal is saturated and looks rather like a rectangular signal. A derived amplitude A′ could be estimated as follows:

$${A}^{′} = \frac{c {ρ}_{G} {f}_{V}}{2 π} . \qquad ( 10 )$$

Therewith, further variables can be determined or the previous calculations checked in comparison to the conventional evaluation via the amplitude value of the measurement signal. By applying the sensitivity c, the amplitude can be eliminated from the calculations and, consequently, does not have to be taken into consideration for the presently discussed volume flow determination. The volume flow rate \dot{V} can thus be ascertained independently of a signal saturation.

In order that a measurement error Eₘ of the measured volume flow of the gaseous phase \dot{V}_{G} in a multiphase flow can be reduced, a correction value K_{G} is required. For determining a suitable correction value K_{G}=f(x, Fr), Equation (2) can first be switched around:

\dot{m}_{G}=\dot{m}_{G,Vortex}·(1−Eₘ) (11)

According to the invention, an option is to describe the measurement error Eₘ purely as a function of the mass flow fraction x and the Froude number Fr, especially the densimetric Froude number, so that the measurement error Eₘ is independent of a pressure p in the line.

Preferably, a form of embodiment of the invention can now provide that in an additional step a correction value K_{G} is determined as a function of the mass flow ratio x and thereafter in a next step the volume flow rate of the gaseous phase 1 is corrected by means of the correction value K_{G}.

For determining the correction value K_{G}, it can, furthermore, be provided that the correction value K_{G} is created from a polynomial of second degree of the mass flow ratio x.

K_{G}=b₀+b₁·x+b₂·x². (12)

The coefficients b₀, b₁ and b₂ are determined, again, simply by means of known approximation methods. In a further development, the correction value K_{G} can also depend on the Froude number Fr, for which other terms can be added to the function. In this regard, other polynomial terms dependent on the Froude number Fr, preferably terms of second degree, can be added to the correction function.

The volume flow rate of the gaseous phase \dot{V}_{G} can be corrected in simple manner by means of K_{G} as follows:

\dot{V}′_{G}=K_{G}·\dot{V}_{G}. (13)

From this corrected volume flow rate of the gaseous phase \dot{V}′_{G}, also a corrected mass flow \dot{m} can be determined for the gaseous phase:

\dot{m}_{G}=ρ_{G}·\dot{V}′_{G}. (14)

With the measured steam quality x, the total mass flow can be determined \dot{m}=\dot{m}_{G}+\dot{m}_{L} and, thus, also the mass flow of the liquid phase \dot{m}_{L}.

$$\dot{m} = \frac{{ρ}_{G} \cdot {\dot{V}}_{G}^{′}}{x} , \\ {\dot{m}}_{L} = \frac{1 - x}{x} {ρ}_{G} \cdot {\dot{V}}_{G}^{′} .$$

Advantageously with this correction method, the measurement uncertainty of the total mass flow can be reduced in a large measuring range to ±2%, whereby an especially exact measuring of the flow rate can be achieved in comparison to an uncorrected flow measuring device.

Finally, the invention can provide that the ascertained values of the mass flow ratio x or the corrected volume flow of the gaseous phase \dot{V}′_{G} or the mass flows \dot{m}, \dot{m}_{G} and \dot{m}_{L} are output for informing a measuring device user. Alternatively, all values can be output. The outputting can occur by means of a display located on the measuring device or by means of a separate display unit. The measured values are available, via an electrical signal line or data line connected to an output unit, also to additional data processing units, such as, for example, one or more computer or process control systems for additional utilization. The measurement data are therewith representable online rapidly and simply.

Furthermore, the invention relates to a vortex flow measuring device for determining the mass flow ratio of a multiphase flow, wherein the vortex flow measuring device comprises
a bluff body for producing Kármán vortices in a flowing medium,
a vortex sensor, especially one placed downstream or within the bluff body, for registering periodic pressure fluctuations caused by Kármán vortices in the flowing medium and for producing a sensor signal (S) corresponding to the pressure fluctuations,
as well as a data processing unit electrically connected with the vortex sensor and adapted, based on the sensor signal (S), to generate at least one output value representing the mass flow ratio (x).

Advantageously, this apparatus provides the ability to determine from the sensor signal S in the measuring device itself the mass flow fraction x as well as all additionally needed, above mentioned variables for the correction value. This must in the case of other measuring devices, in contrast, occur through the use of additional measuring systems. The measuring device can advantageously register the required measured variables, process them and display them to a user rapidly and uncomplicated or provide them as measured values via an output unit.

The measuring device can for performing the above described evaluation of the measurement signal have an evaluating electronics, which can include besides the data processing unit also measuring circuits connected with the sensor or a separate measuring- and control unit for registering and calculating the measurement signals. The data processing unit can for read-out of the calculated measurement data also be connected with a separate computer or a process control system. The data needed for monitoring a flow can therewith be rapidly registered and further processed. If an error occurs, a user can quickly react.

Should the values for the mass flow ratio x or the Froude number exceed a predetermined limit, respectively no longer fall within the measuring range, then according to the invention an alarm system integrated in the measuring device can be activated, wherein besides an acoustic warning also an optical warning can be output on the display of the measuring device. An example of a limit- or threshold value can be, for instance, a steam quality of 80%. Furthermore, the alarm signal can also be placed via the output unit onto the connected fieldbus and therewith reported to the process control system connected via the fieldbus. Therewith, a user can advantageously be warned, when a departure from the measuring range of the measuring device occurs, in order to prevent damage to a plant.

For corrected volume flow determination, respectively the ascertaining of the correction function, all required variables, thus especially the densimetric Froude number Fr′ and the mass flow fraction x, can be measured in the measuring device. In the comparison with the state of the art, this is especially advantageous, since in the case of the other measuring systems, such as Venturi nozzles, orifice or cone difference pressure meters, the mass flow fraction x must be determined via another measuring system. The present measuring can thereby comfortably and rapidly be integrated into existing measuring installations or applied in mobile manner for fast measuring of flows of two or multiphase flows.

Other forms of embodiment, as well as some of the advantages associated with this and additional forms of embodiment, will now be explained further in the following detailed description. In support thereof, reference will also be made to the figures of the drawing. Features, which are essentially equal or very similar, are provided with equal reference characters. The figures of the drawing show as follows:

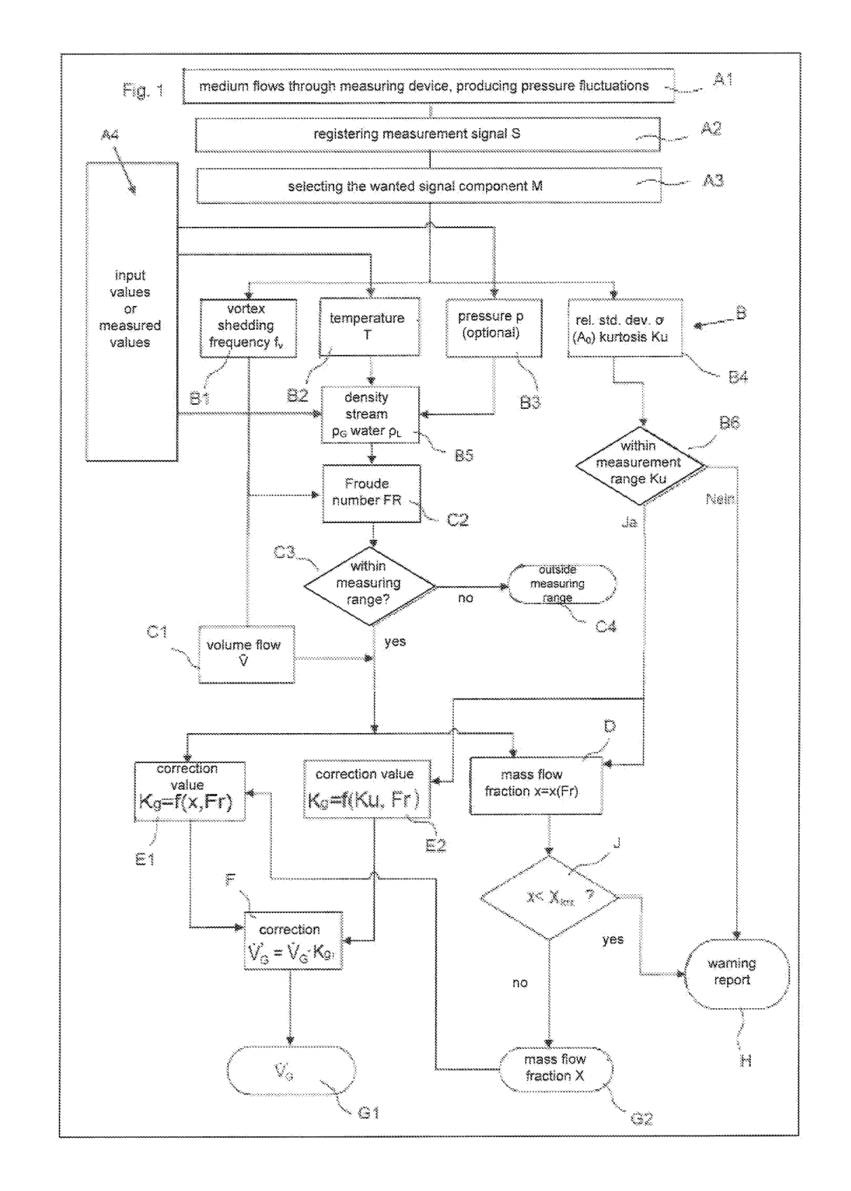

FIG. 1 a flow diagram of the method of the invention,

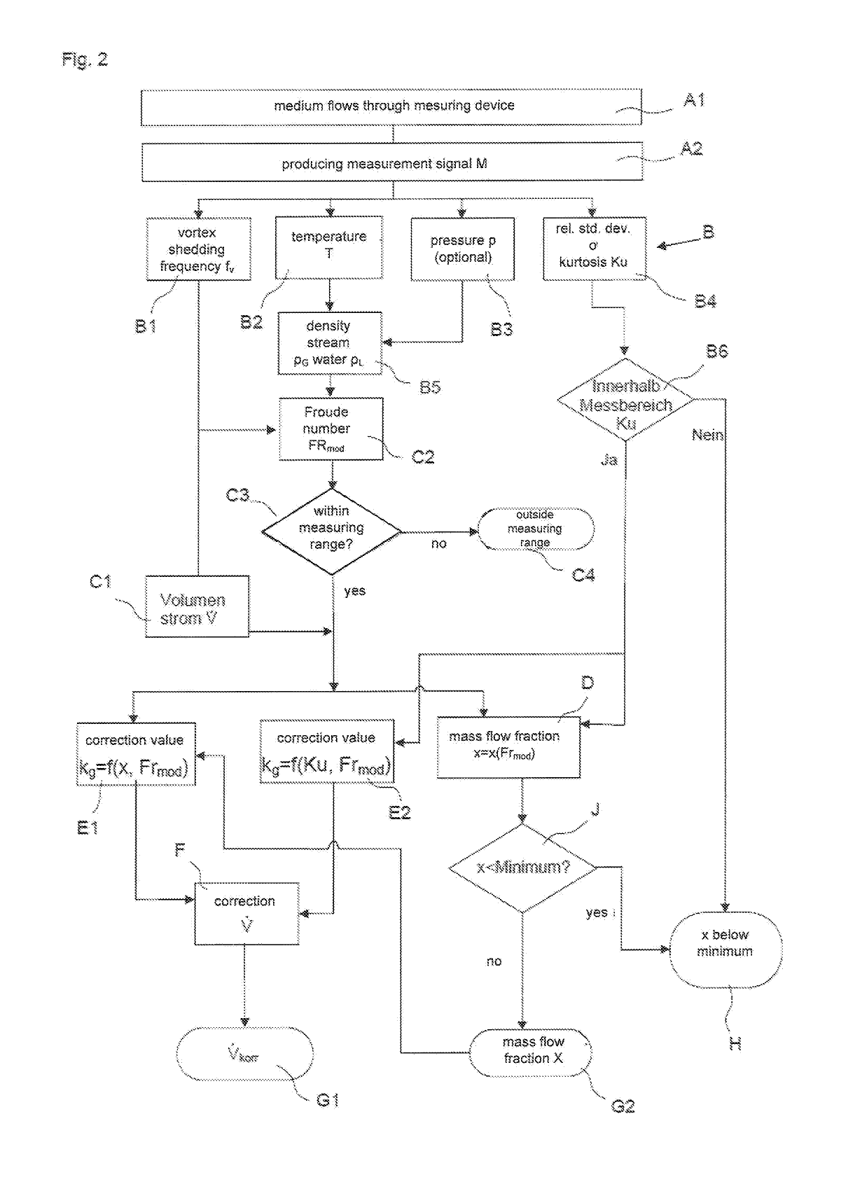

FIG. 2 another flow diagram,

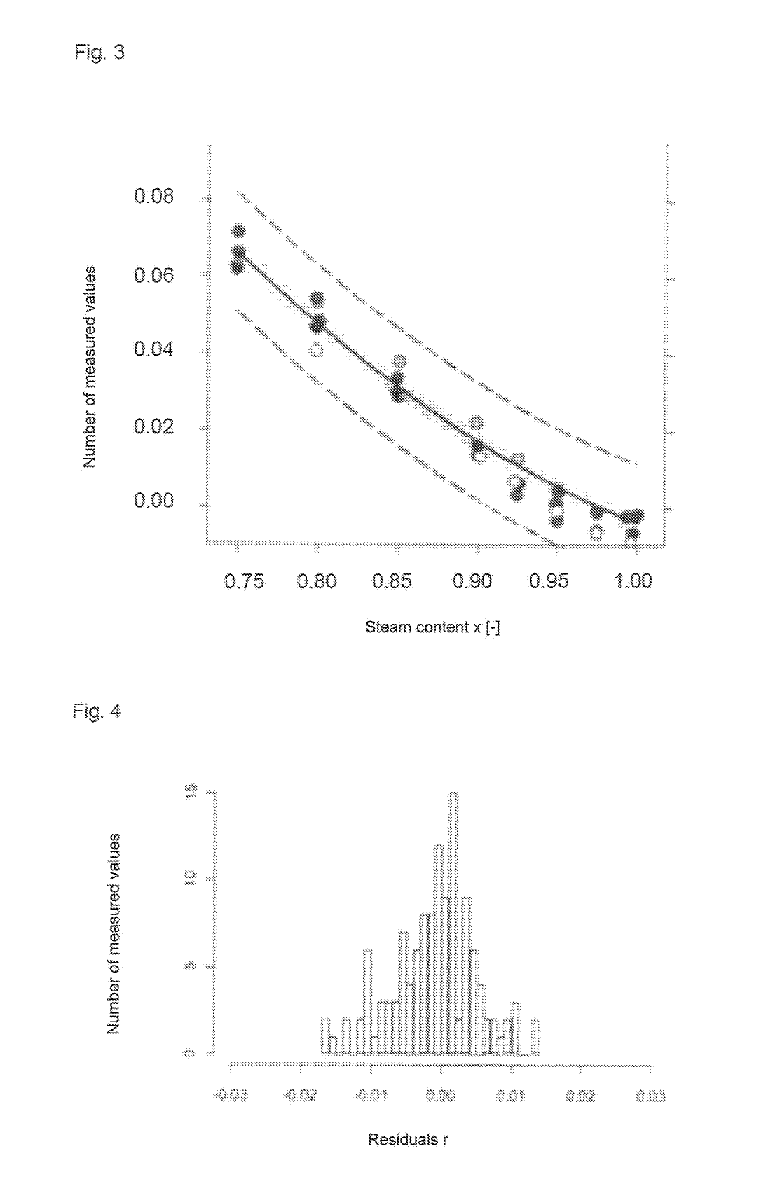

FIG. 3 a graph of error of the measured mass flow of the gaseous phase versus mass flow ratio x,

FIG. 4 a graph of number of measured values versus residuals for a correction function, and

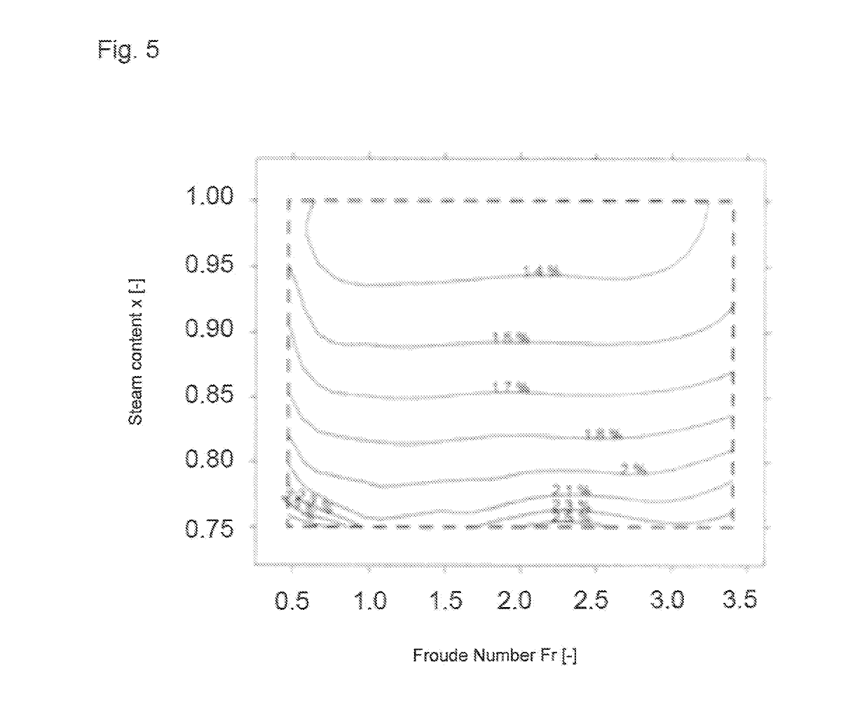

FIG. 5 a graph of measurement uncertainty of the mass flow ratio x as a function of the densimetric Froude number Fr.

FIG. 1 shows a flow diagram of the measuring and the calculations performed in a vortex flow measuring device. The vortex flow measuring device is essentially formed of a measuring tube, in which a medium flows. Such a fluid medium can be liquid or gaseous or even two-phase with a gaseous first phase and a liquid second phase. Examples of two phase mixtures include air and water, respectively steam and water or oil vapor and oil. Other phase compositions or greater than two phases are possible.

Extending into the tube section is a bluff body as a flow impediment, where a Kármán vortex street can form. The vortex flow measuring device includes additionally a measuring-tube section, which extends into the flow. The measuring-tube section includes, furthermore, a sensor, which works as a mechanical to electrical transducer. As a rule, a piezoelectric or capacitive transducer is used.

In step A1, the medium to be measured flows through the measuring tube, wherein at the flow obstruction, the bluff body, a Karman vortex street develops and pressure fluctuations correlating with the flow velocity are produced, which in step A2 are registered by a sensor arranged in the bluff body or thereafter. In such case, the periodic pressure fluctuations caused by the Kármán vortices are converted into an electrical measurement signal and transmitted to an evaluating electronics. The evaluating electronics is arranged within the measuring device and includes a data processing unit, which converts, preferably digitally, the measurement signal into the sensor signal S.

In step A3, the wanted signal component M is selected from the sensor signal S. First of all, a narrow band frequency range around the vortex shedding frequency f_{V} is selected as wanted signal component M. This contains both the information concerning the vortex shedding periods as well as also the information for calculating the mass flow ratio.

In step A4, the evaluating electronics is, furthermore, provided the pressure and temperature of the medium. This happens either by direct input of values into the device by the user or the variables, pressure and temperature, are measured by additional sensor systems in the vortex flow measuring device or read-in via a fieldbus interface (4-20 mA electrical current input, HART, PA, FF).

As above described, now the measurement signals are evaluated, i.e. steps B1 to B4 of the step series B are performed in parallel or in a predetermined sequence. The wanted signal component M is analyzed regarding the vortex shedding frequency f_{V} and the latter determined (step B1) and used in the additional evaluation. Known to those skilled in the art is the determining of the vortex shedding frequency f_{V} from the wanted signal component M.

The wanted signal component M is recorded as a function of time, so that the time fluctuation can be plotted. The wanted signal component is then subjected to a statistical evaluation over a time interval, wherein besides a standard deviation a also the kurtosis Ku is calculated in step B4. Along with that, by means of further sensors, which are arranged in the measuring-tube section, measured variables, such as temperature T (step B2) or optionally also the pressure p (step B3), can be measured or input.

From the measurement signal M and the temperature T and, in given cases, the pressure p, then in step B5 physical variables, such as the density ρ of the medium, density ρ_{G} of the gaseous phase as well as density ρ_{L} of the liquid phase can be determined. The densities of the two phases can, depending on requirements, either be measured internally in the measuring device or externally by means of suitable sensors. The densities can, however, also be input externally or be implementied predetermined in the evaluating electronics, in case the through flowing media and their densities are known.

In the step C2 following thereon, the Froude number Fr, especially the densimetric Froude number Fr′, is calculated with the help of the vortex shedding frequency f_{V} determined in step B1. See Equation (8). Preferably, a densimetric Froude number Fr′ is determined, which is adapted by the specific values of the measuring device to the particular measuring situation.

Calculational steps C3 and B6 check whether the kurtosis Ku, respectively the densimetric Froude number Fr, lie in predetermined measuring ranges.

If the values are outside the measuring ranges, thus, for example, in the case of a Ku greater than 3, the value “mass flow fraction under minimum” (step H) is returned. This shows that the mass flow fraction x is too small. The report can be returned in the form of a warning report, wherein the measuring device outputs an acoustic or optical warning report. In this regard, the values can be output on a display unit, such as a display directly on the measuring device. Furthermore, an alarm signal can also be output via a fieldbus interface (4-20 mA, HART, PA, FF) connected to the output unit.

For a Froude number outside of the measuring range, likewise the value “outside of the measuring range” is output in step C4. In both cases, the evaluation is ended and likewise a warning is output.

If in both decision boxes (steps C3 and B6), the values are within the predetermined measuring range, the calculating is continued and step J executed next.

Furthermore, in step C1, the volume flow rate \dot{V}_{G} is determined from the vortex shedding frequency f_{V}. In step D, then, applying the frequency f_{V}, the densities ρ_{G}, ρ_{L} of the two phases or also the Froude number Fr, especially the densimetric Froude number Fr′, and the kurtosis Ku, the mass flow fraction x is calculated, such as is described in Equations (5) to (7).

In step J, a decision occurs, whether or not the calculated value of the mass flow fraction x falls below a minimum. The case yes likewise leads to step H (see above), while in the other case the value of the mass flow fraction x is returned in step G2 and made available for ascertaining the function for ascertaining the correction value K_{G} in step E1.

In steps E1 and E2, correction values for the gaseous volume flow \dot{V}_{G} can be calculated, respectively, from the mass flow fraction x and the densimetric Froude number Fr′, such as was shown in Equation (12), or from the kurtosis Ku and the densimetric Froude number Fr′. The applied correction function can be selected according to the respective requirements concerning the measurement errors or also the correction functions can be applied in combination.

Finally, in step F the gaseous volume flow rate \dot{V}_{G} can be corrected with the correction value K_{G} according to Equation (13) and thereafter be output (step G1) as corrected gaseous volume flow rate \dot{V}′_{G}.

From the corrected gaseous volume flow rate \dot{V}′_{G}, furthermore, the mass flows \dot{m}_{G} and \dot{m}_{L} of the individual phases as well as the total mass flow \dot{m}_{Tot} can be calculated and output (not shown).

The order of steps is, in such case, not necessarily sequential, but, instead, the steps can also be implemented in parallel.

FIG. 2 shows another flow diagram.

Shown in FIG. 3 are the measured values for Froude numbers Fr from 1 to 1.9. In this region, the influence of the Froude number is so small that these measured values can be shown together in one graph. Additionally, the curve approximately for the correction function for Fr=1.4 is drawn. Moreover, a 95% confidence band CB and a prognosis band PB are shown. The confidence band CB says, in such case, that the course of the correction function based on the present measured values is plausible. The prognosis band PB defines the limits wherein future measured values will scatter with a 95% probability. The determining of this band is known from the state of the art. In this case, measurements showed that no systematic influence of the pressure of the medium flowing in the measuring device, so that pressure is only optionally measured in these calculations.

In order to obtain a measure for reducing the total error, the error FEₘ of the corrected volume flow \dot{V}′_{G} can be estimated by simple error calculation and compared with the previously measured error Eₘ. In FIG. 4, the residuals r of the correction function are shown, which represent the deviations of the measured error Eₘ relative to the error FEₘ calculated with the correction function.

r=E_{\dot{m}}−FE_{\dot{m}}. (15)

The values of the residuals r lie in the range of ±1.5% and have a relative standard deviation σ of about 0.6%.

The standard measurement uncertainty of the mass flow fraction x is presented in FIG. 5. In such case, the mass flow fraction x is plotted versus the Froude number Fr, wherein preferably a measuring range of 0.75-1 is used for the mass flow fraction x (dashed line). The standard measurement uncertainty is shown as solid lines for different mass flow fraction values. Toward the lower limit 0.75, the measurement error Eₘ increased slightly by up to 0.5% points.

Also a total measurement uncertainty according to DIN13005:1999 can be considered, wherein for the calculated correction value the entire measurement uncertainty can be calculated according to Gauss's error propagation law. The total measurement uncertainty is, as a rule, given at a 2-sigma level; this means that of the performed measurements 95% lie within this given measurement uncertainty.

Thus, the corrected mass flow of the gaseous phase is

\dot{m}_{G}=\dot{m}_{G}·(1−E_{\dot{m}}) (16)

Wherein, for the mass flow fraction x, the total mass flow m_{Tot} is

$${\dot{\underline{m}}}_{Tot} = \frac{{\dot{\underline{m}}}_{G}}{x} \qquad ( 17 )$$

from which follows the measurement uncertainty of the total mass flow:

$$Δ {\dot{m}}_{Tot , 2 σ} = 2 \cdot \sqrt{{( \frac{\partial {\dot{\underline{m}}}_{Tot}}{x} \cdot Δ x )}^{2} + {( \frac{\partial {\dot{\underline{m}}}_{Tot}}{{E}_{\dot{m}}} \cdot Δ {E}_{\dot{m}} )}^{2}} . \qquad ( 18 )$$

In such case, it results that the total measurement uncertainty in the case of a mass flow fraction of x=0.9 lies at about 2%. With decreasing mass flow fraction, this increases to 2.7%. The reason for this rise is the higher measurement uncertainty of the mass flow fraction x in this region.

The present invention is not limited to the examples of embodiments explained with reference to the figures. Especially, also alternative, statistical evaluation methods can be applied. Along with that, there are also yet other methods known to those skilled in the art for evaluating the above mentioned measurement signal components as well as for determining the vortex shedding frequency from the measurement signal.

### LIST OF REFERENCE CHARACTERS

| | |
|---|---|
| M | wanted signal component |
| S | sensor signal |
| f_{V} | vortex shedding frequency |
| Eₘ | measurement error mass flow |
| x | mass flow fraction |
| T | temperature |
| p | pressure |
| ρ_{G} ρ_{L} | density, gaseous and liquid phases |
| σ | (relative) standard deviation |
| Ku | kurtosis |
| Fr | Froude number |
| Fr′ | densimetric Froude number |
| \dot{V} | volume flow rate |
| \dot{m} | mass flow rate |
| A-J | method- and calculational steps |

1-19. (canceled)

20. A method for determining by means of a vortex flow measuring device, which has a bluff body protruding into the flowing medium and a vortex sensor, especially a vortex sensor placed downstream or within the bluff body, the mass flow ratio (x) of an at least at times two- or multiphase medium flowing in a measuring tube and having a gaseous first phase flowing with a first mass flow rate \dot{m}_{G} and a liquid second phase flowing with a second mass flow rate \dot{m}_{L}, wherein the gaseous phase has a first density (ρ_{G}), which differs from a second density (ρ_{L}) of the liquid phase, comprising the steps of:
producing Kármán vortices in the flowing medium at least in the region of the vortex sensor by means of the bluff body, wherein the vortices are shed from the bluff body with a vortex shedding frequency (f_{V}) dependent on an instantaneous flow velocity of the flowing medium;
registering by means of the vortex sensor periodic pressure fluctuations caused by the Kármán vortices in the flowing medium for producing a sensor signal corresponding to the pressure fluctuations selecting from the sensor signal a wanted signal component, which has a frequency band, especially a narrow frequency band, containing the vortex shedding frequency, especially with a relative bandwidth less than 50% of the instantaneous vortex shedding frequency, wherein preferably the instantaneous vortex shedding frequency corresponds to the center frequency of the frequency band; and
applying said wanted signal component for determining a mass flow ratio (x) of the flowing medium, wherein:
the mass flow ratio is defined as a ratio of the first mass flow \dot{m}_{G} to a total mass flow, with which the medium flows, especially according to a formula:
$$x = \frac{{\dot{m}}_{G}}{{\dot{m}}_{L} + {\dot{m}}_{G}} .$$

21. The method as claimed in claim 20, further comprising the steps of:
ascertaining at least one fluctuation value of the wanted signal component over a time interval, especially a time interval extending over a number of periods of the pressure fluctuations of the flow, especially a standard deviation (σ) of an amplitude curve of the wanted signal component and/or a kurtosis of the wanted signal component.

22. The method as claimed in claim 21, further comprising the step of:
applying the at least one fluctuation value of the wanted signal component for ascertaining the mass flow ratio (x).

23. The method as claimed in claim 20, further comprising the step of:
ascertaining a sensitivity of the vortex sensor, namely an instantaneous dependence of an amplitude of the wanted signal component on the registered pressure fluctuations, the first density ρ_{G} and the mass flow ratio (x).

24. The method as claimed in claim 23, further comprising the step of:
applying the sensitivity of the vortex sensor for ascertaining the mass flow ratio (x).

25. The method as claimed in claim 20, further comprising the step of:
ascertaining the vortex shedding frequency (f_{V}) based on the sensor signal, especially based on the wanted signal component.

26. The method as claimed in claim 25, further comprising the step of:
applying the vortex shedding frequency (f_{V}) for ascertaining the mass flow ratio (x).

27. The method as claimed in claim 20, further comprising the step of:
ascertaining a Froude number (Fr; Fr′), especially a densimetric Froude number (Fr′), wherein the Froude number Fr is a characteristic variable of the two-, respectively multiphase, medium flowing in the measuring tube dependent on a diameter of the measuring tube, and an empty tube velocity (u_{GS}) of the gaseous first phase, and an acceleration of gravity (g), especially according to the formula:
$$Fr = \frac{{u}_{GS}}{\sqrt{D \cdot g}} .$$

28. The method as claimed in claim 20, further comprising the step of:
ascertaining a densimetric Froude number (Fr′), which corresponds to a Froude number corrected with a ratio of the densities according to the formula
$${Fr}^{′} = \sqrt{\frac{{ρ}_{G}}{{ρ}_{L} - {ρ}_{G}}} \cdot \frac{{u}_{GS}}{\sqrt{D \cdot g}} = \sqrt{\frac{{ρ}_{G}}{{ρ}_{L} - {ρ}_{G}}} \cdot Fr .$$

29. The method as claimed in claim 27, further comprising the step of:
applying the Frouthe number (Fr; Fr′) for ascertaining the mass flow ratio (x).

30. The method as claimed in claim 20, further comprising the step of:
ascertaining, especially by inputting and/or measuring, the density (ρ_{L}, ρ_{G}) for each of the two phases and applying the ascertained densities (ρ_{L}, ρ_{G}) for determining the mass flow ratio (x).

31. The method as claimed in claim 20, further comprising the steps of:
ascertaining, especially by inputting and/or measuring, a temperature; and/or
ascertaining, especially by inputting and/or measuring, a pressure within the two-phase medium for ascertaining the first density (ρ_{G}) of the gaseous phase as well as the second density (ρ_{G}) of the liquid phase.

32. The method as claimed in claim 20, further comprising the step of:
ascertaining a volume flow (\dot{V}_{G}) of the gaseous phase based on the vortex shedding frequency (f_{V}).

33. The method as claimed in claim 32, further comprising the step of:
ascertaining dependent on the mass flow ratio (x) a correction value (K_{G}) for the volume flow rate (\dot{V}_{G}) of the gaseous phase, which correction value (K_{G}) compensates a dependence of the vortex shedding frequency (f_{V}) on the mass flow ratio (x).

34. The method as claimed in claim 33, further comprising the step of: ascertaining a Froude number (Fr; Fr′), especially a densimetric Froude number (Fr′), wherein the Froude number Fr is a characteristic variable of the two-, respectively multiphase, medium flowing in the measuring tube dependent on a diameter of the measuring tube, and an empty tube velocity (u_{GS}) of the gaseous first phase, and an acceleration of gravity (g), especially according to the formula:
$$Fr = \frac{{u}_{GS}}{\sqrt{D \cdot g}} ;$$
applying the Froude number (Fr; Fr′) for ascertaining the correction value (K_{G}).

35. The method as claimed in claim 33, further comprising the step of:
applying the correction value (K_{G}) as well as the ascertained volume flow (\dot{V}_{G}) for ascertaining an output value (\dot{V}′_{G}) for the volume flow of the gaseous phase, especially according to the formula \dot{V}′_{G}=K_{G}·\dot{V}_{G}.

36. The method as claimed in claim 20, further comprising the step of:
ascertaining an output value for the mass flow ratio (x), and displaying said output value for the mass flow ratio (x).

37. The method as claimed in claim 20, further comprising the steps of:
comparing the ascertained mass flow ratio (x) with a predetermined reference value, which represents a critical, especially measuring-point specific, respectively undesired, mass flow ratio; and
outputting a warning, respectively diagnosis report, in the case of determining a deviation of the ascertained mass flow ratio (x) from the reference value.

38. A vortex flow measuring device for implementing a method for determining by means of a vortex flow measuring device, which has a bluff body protruding into the flowing medium and a vortex sensor, especially a vortex sensor placed downstream or within the bluff body, the mass flow ratio (x) of an at least at times two- or multiphase medium flowing in a measuring tube and having a gaseous first phase flowing with a first mass flow rate \dot{m}_{G} and a liquid second phase flowing with a second mass flow rate \dot{m}_{L}, wherein the gaseous phase has a first density (ρ_{G}), which differs from a second density (ρ_{L}) of the liquid phase, comprising the steps of: producing Kármán vortices in the flowing medium at least in the region of the vortex sensor by means of the bluff body, wherein the vortices are shed from the bluff body with a vortex shedding frequency (fᵥ) dependent on an instantaneous flow velocity of the flowing medium; registering by means of the vortex sensor periodic pressure fluctuations caused by the Kármán vortices in the flowing medium for producing a sensor signal corresponding to the pressure fluctuations selecting from the sensor signal a wanted signal component, which has a frequency band, especially a narrow frequency band, containing the vortex shedding frequency, especially with a relative bandwidth less than 50% of the instantaneous vortex shedding frequency, wherein preferably the instantaneous vortex shedding frequency corresponds to the center frequency of the frequency band; and applying said wanted signal component for determining a mass flow ratio (x) of the flowing medium, wherein: the mass flow ratio is defined as a ratio of the first mass flow \dot{m}_{G} to a total mass flow, with which the medium flows, especially according to a formula:
$$x = \frac{{\dot{m}}_{G}}{{\dot{m}}_{L} + {\dot{m}}_{G}} ,$$
which vortex flow measuring device includes:
a bluff body for producing Kármán vortices in a flowing medium;
a vortex sensor, especially a vortex sensor placed downstream or within the bluff body, for registering periodic pressure fluctuations caused by Kármán vortices in the flowing medium and for producing a sensor signal corresponding to the pressure fluctuations; as well as
a data processing unit, electrically connected with the vortex sensor, which is adapted, based on the sensor signal, to generate at least one output value representing the mass flow ratio (x).
